(19) United States
(12) Patent Application Publication
(10) Pub. No.: US 2008/0293867 A1
(43) Pub. Date: Nov. 27, 2008

(54) Thermally Stable Aluminum Hydroxide Particles and Their Use as Fillers in Epoxy Laminate Resins

(75) Inventors: Rene Herbiet, Eupen (BE); Ingo Heim, Frechen (DE); Norbert W. Puetz, Niederaubem (DE)

Correspondence Address: ALBEMARLE CORPORATION;PATENT DEPARTMENT, 451 FLORIDA STREET, BATON ROUGE, LA, 70801, US

(73) Assignee: Albermarle Corporation, Baton Rouge, LA (US)

(21) Appl. No.: 12/089,754

(22) PCT Filed: Oct. 12, 2006
(86) PCT No.: PCT/US06/40241

§ 371 Date: Apr. 10, 2008

Related U.S. Application Data
(60) Provisional application No. 60/728,199, filed on Oct. 18, 2005.
(60) Provisional application No. 60/816,455, filed on Jun. 26, 2006.

(51) Int. Cl. C08K 3/22

(52) U.S. Cl. 524/437

(57) ABSTRACT

Aluminum hydroxide particles having improved thermal stability and their use as a flame retardant in resins suitable for use in epoxy laminates, and laminates containing the same.

### CROSS-REFERENCE TO RELATED APPLICATIONS

The present application claims the benefit of earlier filed U.S. Provisional Applications 60/816,455 and 60/728,199, which are incorporated herein by reference in their entirety.

### FIELD OF THE INVENTION

The present invention relates to the use of particulate aluminum hydroxide. More particularly, the present invention relates to the use of aluminum hydroxide particles having improved thermal stability as a flame retardant.

### BACKGROUND OF THE INVENTION

Aluminum hydroxide has a variety of alternative names such as aluminum hydrate, aluminum trihydrate, aluminum trihydroxide, etc., but is commonly referred to as ATH, and as such, ATH is used herein. ATH particles, finds many uses as a filler in many materials such as, for example, papers, resins, rubber, plastics etc. These products find use in diverse commercial applications such as cable and wire sheaths, conveyor belts, thermoplastics moldings, adhesives, etc. ATH particles are typically used to improve the flame retardancy of such materials and also acts as a smoke suppressant.

Because of the applications in which ATH commonly finds use, the thermal stability of the ATH is a quality closely monitored by end users. For example, in printed circuit board applications, the thermal stability of the laminates used in constructing the boards must be sufficiently high to allow lead free soldering. Thus, there is a need in the art for an ATH having an improved thermal stability.

### BRIEF DESCRIPTION OF THE FIGURES

FIG. 1 is a graph comparing the thermal stability of aluminum hydroxide according to the present invention with present-day commercially available aluminum hydroxides.

FIG. 2 is a graph depicting the mean time to delamination of epoxy resin laminates containing as a filler an ATH according to the present invention, Martinal® OL-104/WE, and Martinal® OL-104/LE.

### SUMMARY OF THE INVENTION

The inventors hereof have unexpectedly discovered that the thermal stability of an ATH is linked to the soda content of the ATH. While empirical evidence indicates that the thermal stability is linked to the total soda content of the ATH, the inventors hereof, while not wishing to be bound by theory, believe that the improved thermal stability of the ATH of the present invention is linked to the non-soluble soda content, which is typically in the range of from about 70 to about 99 wt. %, based on the total soda, of the total soda content, with the remainder being soluble soda. Thus, the present invention relates to a flame retarded resin formulation comprising an ATH having one or more, preferably two or more, and more preferably three or more, of the following characteristics: a d₁₀ in the range of from about 0.5 to about 1.4 μm; a d₅₀ in the range of from about 1.2 to about 3.0 μm; a d₉₀ in the range of from about 2.2 to about 6.0 μm; a total soda content of less than about 0.2 wt. %, based on the ATH, a linseed oil absorption in the range of from about 15 to about 40 ml/100 g as determined by ISO 787-5:1980; and a specific surface area (BET) as determined by DIN-66132 in the range of from about 2.0 to about 8 m²/g, wherein the electrical conductivity of the ATH is less than about 200 μS/cm, measured in water at 10 wt. % of the ATH in water. The flame retardant resin formulation also comprises at least one synthetic resin, and optionally any one or more other additives commonly used in the art

In some embodiments, the ATH of the present invention is further characterized as having a soluble soda content of less than about 0.1 wt. %.

In some embodiments, the present invention relates to ATH particles as described above and below.

### DETAILED DESCRIPTION OF THE INVENTION

ATH as used herein is meant to refer to aluminum hydroxide and the various names commonly used in the art to refer to this mineral flame retardant such as aluminum hydrate, aluminum trihydrate, aluminum trihydroxide, etc.

It should be noted that all particle diameter measurements, i.e. d₁₀, d₅₀, and d₉₀, disclosed herein were measured by laser diffraction using a Cilas 1064 L laser spectrometer from Quantachrome. Generally, the procedure used herein to measure the d₁₀, d₅₀, and d₉₀, can be practiced by first introducing a suitable water-dispersant solution (preparation see below) into the sample-preparation vessel of the apparatus. The standard measurement called “Particle Expert” is then selected, the measurement model “Range 1” is also selected, and apparatus-internal parameters, which apply to the expected particle size distribution, are then chosen. It should be noted that during the measurements the sample is typically exposed to ultrasound for about 60 seconds during the dispersion and during the measurement. After a background measurement has taken place, from about 75 to about 100 mg of the sample to be analyzed is placed in the sample vessel with the water/dispersant solution and the measurement started. The water/dispersant solution can be prepared by first preparing a concentrate from 500 g Calgon, available from KMF Laborchemie, with 3 liters of CAL Polysalt, available from BASF. This solution is made up to 10 liters with deionized water. 100 ml of this original 10 liters is taken and in turn diluted further to 10 liters with deionized water, and this final solution is used as the water-dispersant solution described above.

As stated above, the present invention relates to a flame retarded resin formulation comprising an ATH and at least one synthetic resin. Typically, the flame retarded resin formulation comprises from about 5 to about 200 phr of the ATH. In preferred embodiments, the flame retarded resin formulation comprises in the range of from about 15 to about 100 phr preferably in the range of from about 15 to about 75 phr, more preferably in the range of from about 20 to about 55 phr, of the ATH.

The ATH used in the practice of the present invention is characterized as having one or more, preferably two or more, and more preferably three or more, characteristics. The ATH of the present invention can possess a d₁₀ in the range of from about 0.5 to about 1.4 μm, preferably in the range from about 0.6 to about 1.0 μm, and a d₅₀ in the range of from about 1.2 to about 3.0 μm, preferably in the range of from about 1.3 to about 2.8 μm. In other embodiments, the ATH of the present invention can have a d₅₀ in the range of from about 1.4 to about 2.6 μm.

Another of the one or more characteristics that the ATH of the present invention can possess is a d₉₀ in the range of from about 2.2 to about 6.0 μm, preferably in the range of from about 2.5 to about 5.5 μm. In other embodiments, the ATH of the present invention can have a dgo in the range of from about 2.7 to about 5.0 μm.

Another of the one or more characteristics that the ATH of the present invention can possess is a total soda content of less than about 0.2 wt. %, based on the ATH. In preferred embodiments, if the soluble soda content is a characteristic of the ATH of the present invention, the total soda content is less than 0.18 wt. %, more preferably less than 0.12 wt. %. The total soda content of the ATH can be measured by using a flame photometer M7DC from Dr. Bruno Lange GmbH, Düsseldorf/Germany. In the present invention, the total soda content of the ATH was measured by first adding 1 g of ATH into a quartz glass bowl, then adding 3 ml of concentrated sulfuric acid to the quartz glass bowl, and carefully agitating the contents of the glass bowl with a glass rod. The mixture is then observed, and if the ATH-crystals do not completely dissolve, another 3 ml of concentrated sulfuric acid is added and the contents mixed again. The bowl is then heated on a heating plate until the excess sulfuric acid is completely evaporated. The contents of the quartz glass bowl are then cooled to about room temperature, and about 50 ml of deionized water is added to dissolve any salts in the bowl. The contents of the bowl are then maintained at increased temperature for about 20 minutes until the salts are dissolved. The contents of the glass bowl are then cooled to about 20° C., transferred into a 500 ml measuring flask, which is then filled up with deionized water and homogenized by shaking. The solution in the 500 ml measuring flask is then analyzed with the flame photometer for total soda content of the ATH.

Another of the one or more characteristics that the ATH used in the practice of the present invention can possess is a thermal stability, as described in Table 1 below. Thermal stability, as used herein, refers to release of water of the ATH and can be assessed directly by several thermoanalytical methods such as thermogravimetrical analysis (“TGA”), and in the present invention, the thermal stability of the ATH was measured via TGA. Prior to the measurement, the ATH samples were dried in an oven for 4 hours at about 105° C. to remove surface moisture. The TGA measurement was then performed with a Mettler Toledo by using a 70 μl alumina crucible (initial weight of about 12 mg) under N₂ (70 ml per minute) with the following heating rate: 30° C. to 150° C. at 1° C. per min, 150° C. to 350° C. at 1° C. per min, 350° C. to 600° C. at 10° C. per min. The TGA temperature of the ATH of the present invention can be, and in this instance was, measured at 1 wt. % loss and 2 wt. % loss, both based on the ATH, and the results of these measurements are listed in Table 1 below:

TABLE 1

| | 1 wt. % TGA (° C.) | 2 wt. % TGA (° C.) |
|---|---|---|
| | 210-225 | 220-235 |
| Preferred | 210-220 | 220-230 |
| More Preferred | 214-218 | 224-228 |

The one or more characteristics that the ATH of the present invention can also be selected from i) a linseed oil absorption in the range of from about 15 to about 50 ml/100 g as determined by ISO 787/5, and/or ii) a specific surface area (BET) as determined by DIN 66132 in the range of from about 2.0 to about 8 m²/g. In preferred embodiments, if the linseed oil absorption is a characteristic of the ATH of the present invention, the linseed oil absorption is preferably in the range of from greater than 30 to about 50 ml/100 g, more preferably in the range of from about 36 to about 46 ml/100 g. If the BET is a characteristic of the ATH of the present invention, the BET specific surface area is preferably in the range of from about 2.3 to about 6 m²/g more preferably in the range from about 2.5 to about 4.5 m²/g.

The electrical conductivity of the ATH of the present invention can also be one of the characteristics of the ATH used in the practice of the present invention, and if so, the electrical conductivity is typically in the range of less than about 200 μS/cm. It should be noted that all electrical conductivity measurements were conducted on a solution comprising water and about at 10 wt. % ATH, based on the solution, as described below. Preferably, the electrical conductivity of the ATH of the present invention is less than about 100 μS/cm. In other embodiments of the present invention, the electrical conductivity is in the range of about 20 to about 45 μS/cm. The electrical conductivity was measured by the following procedure using a MultiLab 540 conductivity measuring instrument from Wissenschaftlich-Technische-Werkstätten GmbH, Weilheim/Germany: 10 g of the sample to be analyzed and 90 ml deionized water (of ambient temperature) are shaken in a 100 ml Erlenmeyer flask on a GFL 3015 shaking device available from Gesellschaft for Labortechnik mbH, Burgwedel/Germany for 10 minutes at maximum performance. Then the conductivity electrode is immersed in the suspension and the electrical conductivity is measured.

In other embodiments, the ATH of the present invention can be further characterized as having a soluble soda content of less than about 0.1 wt. %, based on the ATH. In other embodiments, the ATH of the present invention can be further characterized as having a soluble soda content in the range of from greater than about 0.001 to about 0.1 wt. %, in some embodiments in the range of from about 0.02 to about 0.1 wt. %, both based on the ATH. While in other embodiments, the ATH of the present invention can be further characterized as having a soluble soda content in the range of from about 0.001 to less than 0.02 wt %. The soluble soda content is measured via flame photometry. To measure the soluble soda content, a solution of the sample was prepared as follows: 20 g of the sample are transferred into a 1000 ml measuring flask and leached out with about 250 ml of deionized water for about 45 minutes on a water bath at approx. 95° C. The flask is then cooled to 20° C., filled to the calibration mark with deionized water, and homogenized by shaking. After settling of the sample, a clear solution forms in the flask neck, and, with the help of a filtration syringe or by using a centrifuge, as much of the solution as needed for the measurement in the flame photometer can be removed from the flask.

However, if the ATH used in the practice of the present invention is described as having only one characteristic, this characteristic is the non-soluble soda content. The inventors hereof have unexpectedly discovered that the thermal stability of an ATH is linked to the soda content of the ATH. While empirical evidence indicates that the thermal stability is linked to the total soda content of the ATH, the inventors hereof, while not wishing to be bound by theory, believe that the improved thermal stability of the ATH of the present invention is linked to the non-soluble soda content, which is typically in the range of from about 70 to about 99% of the total soda content (as described above, including preferred embodiments), with the remainder being soluble soda, and the total soda content of the ATH used in the practice of the present invention is typically in the range of less than about 0.18 wt. %, based on the ATH, preferably in the range of less than about 0.12 wt. %, on the same basis.

Flame retarded resin formulations of the present invention comprise at least one, in some cases more than one, synthetic resins selected from epoxy resins, novolac resins, phosphorous containing resins like DOPO, brominated epoxy resins, unsaturated polyester resins and vinyl esters.

The flame retarded resin formulation can also contain other additives commonly used in the art. Non-limiting examples of other additives that are suitable for use in the flame retarded polymer formulations of the present invention include other flame retardants based e.g. on bromine, phosphorous or nitrogen; solvents, curing agents like hardeners or accelerators, dispersing agents or phosphorous compounds, fine silica, clay or talc. The proportions of the other optional additives are conventional and can be varied to suit the needs of any given situation.

The preferred methods of incorporation and addition of the components of the polymer formulation is by high shear mixing. For example, by using shearing a head mixer manufactured for example by the Silverson company. Further processing of the resin-filler mix to the “prepreg” stage and then to the cured laminate is common state of the art and described in the literature, for example in the “Handbook of Epoxide Resins”, published by the McGraw-Hill Book Company, which is incorporated herein in its entirety by reference.

The above description is directed to several embodiments of the present invention. Those skilled in the art will recognize that other embodiments, which are equally effective, could be devised for carrying out the spirit of this invention. The following examples will illustrate the present invention, but are not meant to be limiting in any manner.

### EXAMPLES

### Example 1

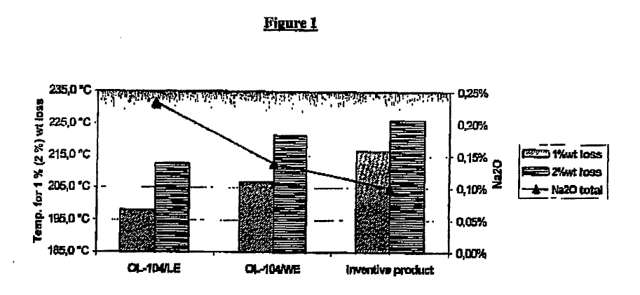

In this example, the thermal stability of two commercially available ATH products, Martinal® OL-104 LE and Martinal® OL-104 WE available from Martinswerk GmbH, was compared to the thermal stability of an ATH of the present invention. The thermal stability was measured according to the TGA test. As illustrated in FIG. 1, ATH grades of the present invention possess superior thermal stability characteristics to those currently available.

### Example 2

In order to further analyze the thermal stability of ATH according to the present invention, epoxy resin laminates (to mimic printed circuit boards) were produced, which were filled with ATH according to the present invention as well as with commercially available grades Martinal® OL-104 LE and OL-104 WE. The epoxy resin laminates were produced by a fabrication technique called hand lay-up (HLU) and the thermal stability was investigated by measuring the time to delamination of 8-layer laminates in a tin bath at 288+/−5° C. following the procedure of the solder float test according to IPC 4101 (IPC-TM-650).

The resin preparation was based on 2 stock mixes, described below.

### Stock Mix 1

Stock mix 1 was produced by dissolving 1250 g Epikote 1001 resin from the Shell Chemicals company in 450 g acetone with the help of a Silverson high speed shearer L4R. After stirring for 20 min the solution (“Epikote base resin”) was clear. It should be noted that stirring was stopped if the temperature exceeded 50° C. to allow the temperature to drop by about 5° C. Then stirring was continued until the solution became clear.

In addition to the Epikote base resin, a dicyandiamide solution (“dicy solution”) was prepared by adding 50 g dicyandiamide to 450 g N,N-dimethylformamide (DMF). 2.5 g 2-methylimidazole were added to the clear solution, which was obtained by using a dissolver from the VMA Getzmann company.

The dicy solution was added to the Epikote base resin and the mix was stirred for 10 min at room temperature. Stock mix 1 was left for 24 h to age.

### Stock Mix 2

Stock mix 2 was based on D.E.N. 438, commercially available from the Dow Chemical Company, Germany. In order to reduce the viscosity of D.E.N. 438 and to measure the needed quantity of 500 g, it was heated up in a water bath to in the range of from about 80 to about 90° C. Afterwards it was cooled down to 50° C. and dissolved in 100 g acetone. The mix was stirred by using a Silverson high shear mixer L4R at 30-40% of the maximum speed.

A second dicyandiamide solution (“second dicy solution”) was prepared by adding 15 g dicyandiamide (dicy) to 180 g N,N-dimethylformamide (DMF). The mixture was stirred by using a dissolver (from the VMA Getzmann company) until the solution was clear, and 1.0 g 2-methylimidazole were then added.

The second dicy solution was added to the D.E.N. 438 base resin and the mixture was stirred for 10 min at room temperature. Stock mix 2 was ready to use after ageing of 24 h.

### Preparation of Epoxy Resin Laminates

The aluminium hydroxide filled epoxy resin was prepared by mixing 100 g of stock mix 1 and 80 g of stock mix 2 together with 1 g Byk LP W 20037 dispersing agent, available commercially from the BYK-Chemie, GmbH, for 1 min at 30-40% of the maximum rotor speed. 50 g of an ATH according to the present invention or 50 g of Martinal® OL-104/WE or 50 g of Martinal® OL-104/LE was then mixed with the epoxy resin to form three different ATH/resin mixtures. The addition of the ATH's was again conducted in the Silverson high shear mixer at 30-40% of the maximum rotor speed during approximately 5 min. Again, if the temperature exceeded 50° C., the mixing was stopped, the temperature was allowed to drop by about 5° C., and mixing was then continued for a total mixing time of approx. 5 min.

For the preparation of the epoxy laminate, a vessel with a width of 300 mm was filled with the ATH/resin mixture. Eight pieces of woven glass cloth (210 g/m²) were cut to a dimension of 180 mm×250 mm and one end of every layer was stapled with 2 strips of wood (5 mm×10 mm×220 mm) at the top and bottom of the glass cloth. The prepared glass cloths were individually dipped into the ATH/resin mixture and were additionally brushed with the ATH/resin mixture in order to guarantee that the whole glass cloth was carrying the resin, thus producing impregnated glass cloths.

The impregnated glass cloth was fixed at a laboratory stand. Surplus resin was removed by rolling two round metal bars over the surface of the impregnated glass cloth. The glass cloth was dried for 90 seconds at 160° C. in an oven and was allowed to cool down to room temperature. The resin content of every dried layer, as determined by weighing the prepared glass cloths pre resin application and post resin application, was between 38 wt. % and 42 wt. %. The glass cloths were cut to a dimension of 150 mm×200 mm. 8 layers were piled and 2 plies of Tedlar®, commercially available from Dupont, were added at the top and bottom of the cut glass cloths. The piles were pressed for 2 h at 170° C. with a pressure of 195 kp/cm². After cooling down to room temperature the plies of Tedlar® were removed. The resulting 8-layer laminate had a resin content of in the range of from about 38 to about 42 wt. %, and a thickness of 0.8 mm.

Each 8-layer cloth was then cut into 9 test sections measuring 40 mm×50 mm. The thermal stability of the 8-layer epoxy resin laminate was investigated by measuring the time to delamination of each test section as follows. The test item was fixed in a holder that was dipped into a stannous bath at 288+/−5° C. The time was measured until first delamination occurred. Delamination was detected by an impact on the holder and afterwards confirmed via visual control. Delamination was caused by the endothermic decomposition of aluminium hydroxide into alumina and water. Epoxy resin laminates which were produced according to the above-mentioned procedure and which did not contain aluminium hydroxide did not exhibit delamination after 10 min.

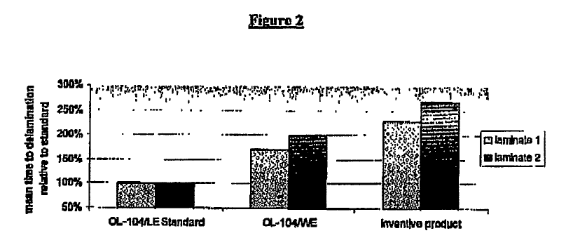

FIG. 2 illustrates the relative mean time to delamination of the test sections containing as a filler the ATH of the present invention compared to the test sections containing Martinal® OL-104/WE and Martinal® OL-104/LE, thereby the mean time to delamination of the latter was set to 100%. The presented time to delamination is the average value of 9 test items based on one 8-layer epoxy resin laminate. The results of 2 laminates are shown, which were produced separately according to the above-mentioned procedure.

As shown in FIG. 2, epoxy resin laminates using as a filler ATH particles according to the present invention exhibit thermal stabilities, as determined by the mean time to delamination, superior to those resins containing conventional ATH's as fillers.

What is claimed:

1) A flame retarded resin formulation comprising:
a) aluminum hydroxide (“ATH”) particles having at least one or more of the following characteristics: i) a d₁₀ in the range of from about 0.5 to about 1.4 μm; ii) a d₅₀ in the range of from about 1.2 to about 3.0 μm; iii) a d₉₀ in the range of from about 2.2 to about 6.0 μm; iii) a total soda content of less than about 0.2 wt. %, based on the ATH, iv) a linseed oil absorption in the range of from about 15 to about 50 ml/100 g; and v) a BET specific surface area in the range of from about 2.0 to about 8 m²/g; and
b) at least one synthetic resin,
wherein the electrical conductivity of the ATH is less than about 200 μS/cm.

2) The flame retarded resin formulation according to claim 1, wherein said ATH has a soluble soda content of less than about 0.1 wt. %,

3) The flame retarded resin formulation according to claim 2, wherein said ATH has
i) a d₁₀ in the range of from about 0.6 to about 1.0 μm; and/or ii) a d₅₀ in the range of from about 1.3 to about 2.8 μm or a d₅₀ in the range of from about 1.4 to about 2.6 μm; and/or iii) a d₉₀ in the range of from about 2.5 to about 5.5 μm or a d₉₀ in the range of from about 2.7 to about 5.0 μm.

4) The flame retarded resin formulation according to claim 3, wherein said ATH has a total soda content of less than 0.18 wt. %.

5) The flame retarded resin formulation according to claim 3, wherein said ATH has a total soda content of less than 0.12 wt. %, based on the ATH.

6) The flame retarded resin formulation according to any of claims 3-5, wherein said ATH has a TGA profile of:

| 1 wt. % TGA (° C.) | 2 wt. % TGA (° C.) |
|---|---|
| 210-225 | 220-235 |

or

| | |
|---|---|
| 210-220 | 220-230 |

or

| | |
|---|---|
| 214-218 | 224-228 |

7) The flame retarded resin formulation according to claim 6, wherein said ATH has a linseed oil absorption in the range of from greater than 30 to about 50 ml/100 g.

8) The flame retarded polymer formulation according to claim 7, wherein said ATH has a BET specific surface area in the range of from about 2.3 to about 6 m²/g.

9) The flame retarded resin formulation according to any of claims 4 or 5 wherein said ATH has a soluble soda content in the range of from about 0.001 to about 0.1 wt. %, based on the ATH.

10) The flame retarded resin formulation according to any of claims 4 or 5, wherein said ATH has a soluble soda content in the range of from about 0.001 to less than 0.02 wt %.

11) The flame retarded resin formulation according to claim 9 wherein the non-soluble soda content of said ATH is in the range of from about 70 to about 99 wt. %, based on the total soda, of the total soda content.

12) The flame retarded resin formulation according to claim 11, wherein said ATH has an electrical conductivity of less than about 100 μS/cm.

13) The flame retarded resin formulation according to claim 10, wherein said ATH has an electrical conductivity in the range of from about 20 to about 45 μS/cm.

14) A flame retarded resin formulation comprising:
a) an aluminum hydroxide (“ATH”) having at least one or more of the following characteristics: i) a d₁₀ in the range of from about 0.6 to about 1.0 μm; ii) a d₅₀ in the range of from about 1.3 to about 2.6 μm; iii) a d₉₀ in the range of from about 2.7 to about 5.0 μm; iii) a total soda content of less than about 0.12 wt. %, based on the ATH, iv) a linseed oil absorption in the range of from about 15 to about 50 ml/100 g; and v) a BET specific surface area in the range of from about 2.0 to about 6 m²/g; and
b) at least one synthetic resin,
wherein the at least one synthetic resin is selected from epoxy resins, novolac resins, phosphorous containing resins, brominated epoxy resins, unsaturated polyester resins and vinyl esters, the electrical conductivity of the ATH is less than about 100 μS/cm, said ATH has a soluble soda content of less than about 0.1 wt. %, and a TGA profile of:

| 1 wt. % TGA (° C.) | 2 wt. % TGA (° C.) |
|---|---|
| 210-225 | 220-235 |

15) The flame retarded resin formulation according to claim 14 wherein said ATH has a TGA profile of:

| 1 wt. % TGA (° C.) | 2 wt. % TGA (° C.) |
|---|---|
| 210-220 | 220-230 |

or

| | |
|---|---|
| 214-218 | 224-228 |

16) The flame retarded resin formulation according to claim 15, wherein said ATH has a linseed oil absorption in the range of from greater than 30 to about 50 ml/100 g.

17) The flame retarded polymer formulation according to claim 16, wherein said ATH has a BET specific surface area in the range of from about 2.5 to about 4.5 m²/g.

18) The flame retarded resin formulation according to any of claims 15 or 17 wherein said ATH has a soluble soda content in the range of from about 0.001 to about 0.1 wt. %, based on the ATH.

19) The flame retarded resin formulation according to any of claims 15 or 17, wherein said ATH has a soluble soda content in the range of from about 0.001 to less than 0.02 wt %.

20) The flame retarded resin formulation according to claim 19 wherein the non-soluble soda content of said ATH is in the range of from about 70 to about 99 wt. %, based on the total soda, of the total soda content.

21) The flame retarded resin formulation according to claim 19, wherein said ATH has an electrical conductivity in the range of from about 20 to about 45 μS/cm.

22) An epoxy laminate made from the flame retarded resin formulation of claim 21.

23) An epoxy laminate made from the flame retarded resin formulation of claim 14.

24) ATH having a d₁₀ in the range of from about 0.6 to about 1.0 μm; a d₅₀ in the range of from about 1.2 to about 3.0 μm; a d₉₀ in the range of from about 2.5 to about 6.0 μm; a total soda content of less than about 0.2 wt. %, based on the ATH, a linseed oil absorption in the range of from about 15 to about 40 ml/100 g, as determined by ISO 787-5:1980; and a specific surface area (BET), as determined by DIN-66132, of in the range of from about 2.0 to about 5 m²/g, wherein the electrical conductivity of the ATH is less than about 200 μS/cm, measured in water at 10 wt. % of the ATH in water.

25) The ATH according to claim 24, wherein said ATH has a soluble soda content of less than about 0.1 wt. %.

26) The ATH according to claim 25, wherein said ATH has a d₁₀ in the range of from bout 0.6 to about 1.0 μm.

27) The ATH according to claim 26, wherein said ATH has a d₅₀ in the range of from about 1.3 to about 2.8 μm.

28) The ATH according to claim 25, wherein said ATH has a d₅₀ in the range of from about 1.4 to about 2.6 μm.

29) The ATH according to claim 27, wherein said ATH has a d₉₀ in the range of from about 2.5 to about 5.5 μm.

30) The ATH according to claim 28, wherein said ATH has a d₉₀ in the range of from about 2.7 to about 5.0 μm.

31) The ATH according to claim 29, wherein said ATH has a total soda content of less than 0.18 wt. %.

32) The ATH according to claim 30, wherein said ATH has a total soda content of less than 0.12 wt. %, based on the ATH.

33) The ATH according to claim 25, wherein said ATH has a thermal stability, as determined by thermogravimetrical analysis (TGA) of:

| 1 wt. % TGA (° C.) | 2 wt. % TGA (° C.) |
|---|---|
| 210-225 | 220-235 |

34) The ATH according to claim 31, wherein said ATH has a thermal stability, as determined by thermogravimetrical analysis (TGA) of:

| 1 wt. % TGA (° C.) | 2 wt. % TGA (° C.) |
|---|---|
| 210-220 | 220-230 |

35) The ATH according to claim 32, wherein said ATH has a thermal stability, as determined by thermogravimetrical analysis (TGA) of:

| 1 wt. % TGA (° C.) | 2 wt. % TGA (° C.) |
|---|---|
| 214-218 | 224-228 |

36) The ATH according to claim 34, wherein said ATH has a linseed oil absorption in the range of from greater than about 30 to about 40 ml/100 g.

37) The ATH according to claim 36, wherein said ATH has a BET specific surface area in the range of from about 2.3 to about 4.3 m²/g.

38) The ATH according to claim 34, wherein said ATH has an electrical conductivity of less than about 100 μS/cm, measured in water at 10 wt. % of the ATH in water.

39) The ATH according to claim 35, wherein said ATH has an electrical conductivity is in the range of about 20 to about 45 μS/cm, measured in water at 10 wt. % of the ATH in water.

40) The ATH according to claim 38, wherein said ATH has a soluble soda content in the range of from greater than about 0.02 to about 0.1 wt. %, based on the ATH.

41) The ATH according to claim 38, wherein said ATH has a soluble soda content in the range of less than 0.02 wt %.

42) The ATH according to claim 25 wherein the non-soluble soda content of said ATH is in the range of from about 70 to about 99 wt. %, based on the total soda, of the total soda content.
